(19) United States
(12) Patent Application Publication
(10) Pub. No.: US 2025/0319789 A1
(43) Pub. Date: Oct. 16, 2025

(54) METHOD FOR OPERATING AN ELECTRICAL POWER SUPPLY DEVICE, SWITCH-OFF CONTROL DEVICE, SWITCH-OFF UNIT, AND POWER SUPPLY DEVICE

(71) Applicant: ads-tec Energy GmbH, Nürtingen (DE)

(72) Inventors: Holger DREHER, Holzgerlingen (DE); Holger OCHS, Mötzingen (DE)

(21) Appl. No.: 19/176,281

(22) Filed: Apr. 11, 2025

(30) Foreign Application Priority Data
Apr. 11, 2024 (DE) 102024110209.8

(51) Int. Cl. B60L 53/62; B60L 53/20; B60L 53/66; H02H 3/10; H02H 3/20

(52) U.S. Cl. CPC B60L 53/62; B60L 53/20; B60L 53/66; H02H 3/10; H02H 3/202

(57) ABSTRACT

The invention relates to a method for operating an electrical power supply device (1) for unidirectional or bidirectional charging of an energy storage device (2), wherein
data of the data transmission between the power supply device (1) and the energy storage device (2) is received at least during a charging process, wherein the data contains at least one limit charging parameter which is characteristic of the charging process, wherein
in dependence on the at least one limit charging parameter, an actual emergency switch-off threshold of the power supply device (1) is set for a charging parameter, wherein
if the charging parameter exceeds the actual emergency switch-off threshold, an emergency measure is carried out to protect the power supply device (1) and/or the energy storage device (2) from damage.

The invention also relates to a switch-off control device (5) for carrying out such a method, a switch-off unit with such a switch-off control device (5) and a power supply device (1) with such a switch-off control device (5) and/or with such a switch-off unit.

The invention relates to a method for operating an electrical power supply device for unidirectional or bidirectional charging, in particular of an energy storage device, a switch-off control device, a switch-off unit, and a power supply device.

When charging an energy storage device, in particular an electric vehicle, by means of a power supply device, it is necessary to ensure that a maximum charging amperage and/or a maximum charging voltage is not exceeded to prevent damage to the energy storage device and/or the power supply device. In particular, it must be ensured that an electrical connection, in particular a power circuit, is interrupted in the event of a malfunction of the power supply device and/or the electrical energy storage device.

It is known that electric vehicles have a fuse that interrupts the power circuit in the event of a malfunction of the power supply device. If, for example, a short circuit occurs in the power supply device during a bidirectional charging process-when the electric vehicle is transmitting electrical energy to the power supply device—the electric vehicle transmits energy to the power supply device at such a high power that the fuse of the electric vehicle trips. The disadvantage of these fuses is that, when opened under a high current load, they have to be replaced after just a few switching operations or are even destroyed the first time they are tripped. Such fuses can also be integrated into an electric vehicle battery and, in the worst case, damage the battery if they are tripped. The electric vehicle is no longer functional after the fuse has tripped. To restore the functionality of the electric vehicle functionality, the electric vehicle must be towed and the fuse replaced and/or activated manually. Alternatively, the entire battery must be replaced after the fuse has tripped.

It is also known that the power supply devices can have fuses. The fuses are configured to interrupt the power circuit in the event of a malfunction of the power supply device. The disadvantage of this is that the reaction time of these fuses is so long that both the fuse of the power supply device and the fuse of the electric vehicle are tripped. Furthermore, it is not possible to interrupt the power circuit in the event of a malfunction of the power supply device before the electric vehicle fuse is tripped and thus maintain the functionality of the electric vehicle. Another problem is that a wide variety of vehicles, from small cars to trucks, can be charged at such a power supply device, wherein the limiting charging parameters, such as the maximum charging amperage, differ greatly.

For example, during a discharging process it can happen that a fuse in a small car trips at a certain charging amperage, wherein a commercial vehicle could have been discharged at this charging amperage without any problems. The power supply device also does not know the tripping characteristics of the fuse of the electric vehicle and the fuse thus cannot be protected.

The object of the invention is thus to provide a method for operating an electrical power supply device for charging an energy storage device, a switch-off control device, a switch-off unit and a power supply device, wherein the aforementioned disadvantages are at least reduced, preferably avoided.

The object is solved by providing the present technical teaching, in particular the teaching of the independent claims and the embodiments disclosed in the dependent claims and the description.

The object is solved in particular by creating a method for operating an electrical power supply device, in particular a charging station, for unidirectional or bidirectional charging of an energy storage device, in particular a battery storage of an electric vehicle. In the method, data of a data transmission between the power supply device and the energy storage device is received during a charging process. The data contains at least one limit charging parameter which is characteristic of the charging process. In dependence on the at least one limit charging parameter, an actual emergency switch-off threshold of the power supply device is set for a charging parameter. If the charging parameter exceeds the actual emergency switch-off threshold, an emergency measure is carried out, in particular to protect the power supply device and/or the energy storage device from damage.

Advantageously, the method can be used to detect and use a communication between the energy storage device and the power supply device to flexibly adjust the trigger characteristic—the actual emergency switch-off threshold—of the emergency measure to the respective energy storage device, in particular to the limit charging parameter thereof, for example a maximum charging amperage. This makes it possible to interrupt the power circuit of the electrical power supply device in the event of a malfunction of the same before an energy storage device registers the malfunction and, in particular, before a fuse of the energy storage device is tripped. By means of the variably adjusted actual emergency switch-off threshold, an emergency measure can be carried out earlier in time than by means of a fixed switch-off threshold of the power supply device, as is used for many energy storage devices. For example, the actual emergency switch-off threshold can be adjusted to the limit charging parameter, such as the maximum charging amperage, of a wide range of electric vehicles—from small cars to trucks. This can prevent the fuse of a small car from tripping. Although it is not known to the power supply device that a small car is being charged, a limit charging parameter, for example a maximum charging amperage, is known to the power supply device. Furthermore, it is advantageously not necessary to know a tripping characteristic and/or a rated current of a fuse of the electric vehicle, so that the method can also be used to protect energy storage devices from damage that have fuses with different tripping characteristics and/or rated currents. Critical short circuits with a high rate of amperage increase—i.e. a comparatively high amperage gradient—are also prevented by interrupting the power circuit at a still permissible charging amperage in relation to the currently connected energy storage device and thus ending the charging process. It is also possible to realize a comparatively small distance between a charging amperage that characterizes a fault-free charging process and the actual emergency switch-off threshold. The actual emergency switch-off threshold is preferably set at the beginning of a charging process, but can also optionally be set again during the charging process, in particular once or several times, in particular cyclically, and thus dynamically adjusted.

In the context of the present technical teaching, the term “charging” is understood to mean not only charging but also, in particular, discharging. In particular, the energy storage device is charged by the power supply device during a charging process. In particular, the energy storage device is discharged during a discharge process, wherein the energy is transferred to the power supply device. The transmitted energy can be passed on to a power grid to which the power supply device is connected to stabilize or temporarily support such power grid. The power supply device thus serves as an access point to the power grid. Alternatively or in addition, a device energy storage unit of the power supply device can be charged with the transmitted energy. Unidirectional charging typically comprises only charging processes, while bidirectional charging comprises both charging and discharging processes. In the context of the present technical teaching, a charging parameter is thus understood in particular to be a charging parameter and a discharging parameter.

In the context of the present technical teaching, a limit charging parameter is thus understood in particular to be a limit charging parameter and a limit discharging parameter.

In the context of the present technical teaching, a positive charging current is an energy transfer from the power supply device to the energy storage device—i.e. a charging. Furthermore, in the context of the present technical teaching, a negative charging current is an energy transfer from the energy storage device to the power supply device—i.e. a discharging.

In electrical engineering, a power supply device, in particular a charging station, is any device or electrical system, in particular stationary or mobile, which is used to supply energy to mobile battery-powered devices, machines or motor vehicles by simply positioning them or plugging them in without necessarily having to remove the energy storage system-such as the traction battery of an electric car. Charging stations for electric cars are sometimes also referred to as “electric filling stations” and can include a plurality of charging points. High performance charging systems or high power charging system (HPC systems) such as the combined charging system (CCS), which is widespread in Europe, are particularly well known. With generic direct current charging, direct current from the charging station is fed directly into the battery of the vehicle and provided by a powerful rectifier, preferably of the charging station, from the power grid or by large buffer accumulators at solar charging stations, for example. There is a battery management system in the vehicle that communicates directly or indirectly with the charging station to adjust the amperage and voltage or to terminate the process when a predetermined capacity limit is reached. Power electronics are usually located in the charging station. Since the direct current connections of the charging station are connected directly to the corresponding terminals of the traction battery—without a detour via an AC/DC converter of the vehicle—high charging currents can be transmitted with low losses, which enables short charging times.

In one embodiment, the charging station is designed as a charging pole. In particular, the charging station has at least one charging point, in particular exactly one charging point or exactly two charging points.

In particular, the charging station is designed as a fast charging station. In one embodiment, the charging station is designed as a battery-supported charging station, in particular as a battery-supported fast charging station.

In particular, the charging parameter is an instantaneous charging parameter, for example an instantaneous charging power, an instantaneous charging voltage or an instantaneous charging amperage with which the power supply device and/or the energy storage device is charged. The charging parameter is acquired in the usual manner by a control device of the power supply device or is known to the control device. The charging parameter should not be confused with the limit charging parameter received from the data transmission, which is preferably a maximum charging parameter—i.e. a maximum permissible charging parameter specified in particular by the power supply device and/or the energy storage device—or a charging parameter request—i.e. an instantaneously desired charging parameter specified in particular by the power supply device and/or the energy storage device.

In one embodiment, the method monitors a bidirectional charging current. Advantageously, this also makes it possible to monitor a charging current from the energy storage device to the electrical power supply device. In particular, this can be used to charge the device energy storage of the power supply device or to stabilize or temporarily support a power grid. Advantageously, even in the event of a malfunction of the power supply device during bidirectional charging, it can be avoided that a fuse of the energy storage device is tripped and, for example, an electric vehicle is no longer functional. Rather, it is avoided that the fuse of the electric vehicle is even exposed to operation with charging parameters that deviate from normal operation. This is particularly advantageous for batteries that have an integrated fuse. Because the fuse is not tripped, these batteries no longer need to be replaced at great expense. Advantageously, towing and repairing the electric vehicle can be avoided altogether.

In one embodiment, the charging parameter is given unsigned, in particular as an amount, squared amount or square root of the squared amount. Accordingly, the actual emergency switch-off threshold is preferably an unsigned variable, in particular an amount. Thus, the charging parameter exceeding the assigned actual emergency switch-off threshold means in particular that its amount becomes greater than the actual emergency switch-off threshold, regardless of the sign of the charging parameter.

In one embodiment, it is provided that a temporal charging parameter gradient of the charging parameter which is characteristic of the charging process is acquired during the charging process. If a fault of the charging process is inferred on the basis of the charging parameter gradient, the emergency measure is carried out to protect the power supply device and/or the energy storage device from damage.

In one embodiment, it is provided that the charge parameter gradient is acquired directly, wherein the charge parameter gradient is compared with a predetermined gradient threshold value as the actual emergency switch-off threshold. A fault of the charging process is inferred if the charging parameter gradient acquired exceeds the predetermined gradient threshold value. Alternatively, it is provided that the charging parameter gradient is indirectly acquired by measuring a measurement parameter which is characteristic of the charging parameter gradient, wherein the measurement parameter is compared with a predetermined measurement parameter threshold value as an actual emergency switch-off threshold, wherein a fault of the charging process is inferred if the measurement parameter exceeds the predetermined measurement parameter threshold value.

According to a further development of the invention, it is provided that the actual emergency switch-off threshold is set by determining a nominal emergency switch-off threshold of the power supply device for the charging parameter in dependence on the at least one limit charging parameter. It is checked whether a current actual value of the actual emergency switch-off threshold of the power supply device is equal to a nominal value of the nominal emergency switch-off threshold, in particular whether it has the same value. If the current actual value is not equal to the nominal value, in particular does not have the same value, the actual emergency switch-off threshold is adjusted so that a new actual value of the actual emergency switch-off threshold is equal to the nominal value, in particular has the same value.

In one embodiment, it is provided that the method or at least one step of the method is repeated, in particular cyclically, in particular at a frequency of 10 kHz to 50 kHz. In particular, the method or at least one step of the method is repeated during the charging process, in particular cyclically, in particular at a frequency of 10 kHz to 50 kHz.

According to a further development of the invention, it is provided that, as an emergency measure, a power circuit of power electronics, in particular of the power supply device and/or the energy storage device, is interrupted, in particular in such a way that the charging process is interrupted.

Advantageously, this effectively prevents damage to the power supply device and/or the energy storage device.

According to a further development of the invention, it is provided that the limiting charge parameter is selected from a group consisting of: A maximum charging power of the power supply device, a maximum charging power of the energy storage device, a maximum charging voltage of the power supply device, a maximum charging voltage of the energy storage device, a maximum charging amperage of the power supply device, a maximum charging amperage of the energy storage device, an instantaneous power request of the energy storage device, an instantaneous power request of the power supply device, an instantaneous voltage request of the energy storage device, an instantaneous voltage request of the power supply device, an instantaneous amperage request of the energy storage device, an instantaneous amperage request of the power supply device, an instantaneous charging power gradient, an instantaneous charging voltage gradient and an instantaneous charging amperage gradient.

Advantageously, the actual emergency switch-off threshold can be flexibly adjusted to different energy storage devices. For example, the actual emergency switch-off threshold can be set lower for a small electric vehicle with a maximum charging amperage of 125 A—at a charging voltage of 400 V this results in a charging power of 50 kW—than for a commercial electric vehicle with a maximum charging amperage of 625 A—at a charging voltage of 400 V this results in a charging power of 250 kW—for which the actual emergency switch-off threshold is set higher. Thus, various electric vehicles can be protected from damage.

In one embodiment, in particular if the energy storage device is part of an electric vehicle, the charging limit parameter is selected to be a parameter defined in the IEC61851-24 standard in its version valid on the date determining the priority date of the present IP right. In particular, the limit charge parameter is selected from a group consisting of: A maximum charging amperage of the electric vehicle, a maximum charging voltage of the electric vehicle, a current request for the controlled current charging (CCC) system, a voltage request for the controlled voltage charging (CVC) system, a maximum rated voltage of a direct current power supply device for electric vehicles, a maximum rated current of a direct current power supply device for electric vehicles, and an instantaneously available charging current of the power supply device.

According to a further development of the invention, it is provided that the actual emergency switch-off threshold is additionally set in dependence on a first tolerance value. The first tolerance value is characteristic of a tolerance of the charging process, in particular of the charging parameter. Advantageously, this prevents the emergency measure from being carried out because of an operationally normal fluctuation in the charging parameter—which is unable to cause damage.

In particular, the first tolerance value increases the actual emergency switch-off threshold.

In one embodiment, the actual emergency switch-off threshold is set by first receiving the limit charging parameter mediated via the data of the data transmission. The limit charging parameter can then be increased by the first tolerance value, wherein the nominal emergency switch-off threshold is maintained. This can then be compared with the actual emergency switch-off threshold and, if they are different, the actual value of the actual emergency switch-off threshold can be set to the nominal value of the nominal emergency switch-off threshold.

In one embodiment, in particular if the energy storage device is part of an electric vehicle, the first tolerance value is selected to be a value defined in the IEC61851-23 standard in its version valid on the date determining the priority date of the present IP right. In particular, if an amperage is used as the limit charging parameter, the first tolerance value is.
150 mA if the current amperage request is less than 5 A,
1.5 A if the current amperage request is equal to or greater than 5 A and less than or equal to 50 A, and
3% of an instantaneous charging amperage if the instantaneous amperage request is greater than 50 A.

In one embodiment, the actual emergency switch-off threshold is set—in particular additionally—in dependence on a second tolerance value, wherein the second tolerance value is characteristic of a triggering tolerance of the emergency measure. In particular, the triggering tolerance of the emergency measure is dependent on an instantaneous temperature of a switch-off arrangement carrying out the emergency measure and/or a degree of aging of electronic components of the switch-off arrangement.

In particular, the second tolerance value is up to 20% of the charging parameter or the limit charging parameter.

In particular, the second tolerance value increases the actual emergency switch-off threshold.

In one embodiment, the first tolerance value and/or the second tolerance value is given unsigned, in particular as an amount, squared amount or square root of the squared amount. The first tolerance value and/or the second tolerance value increasing the actual emergency switch-off threshold thus means, in particular, that it increases the amount of the actual emergency switch-off threshold.

In one embodiment, the actual emergency switch-off threshold is set by first receiving the limit charging parameter mediated via the data of the data transmission. The limit charging parameter can then be increased by the second tolerance value, wherein the nominal emergency switch-off threshold is maintained. This can then be compared with the actual emergency switch-off threshold and, if they are different, the actual value of the actual emergency switch-off threshold can be set to the nominal value of the nominal emergency switch-off threshold. In another embodiment, the actual emergency switch-off threshold is set by first receiving the limit charging parameter mediated via the data of the data transmission. The limit charging parameter can then be increased by the first tolerance value and by the second tolerance value, wherein the nominal emergency switch-off threshold is maintained. This can then be compared with the actual emergency switch-off threshold and, if they are different, the actual value of the actual emergency switch-off threshold can be set to the nominal value of the nominal emergency switch-off threshold.

In one embodiment, the actual emergency switch-off threshold is set such that it is above a first limit charging parameter of the limit charging parameters and below a second limit charging parameter of the limit charging parameters of the same type, i.e. having the same physical dimension and/or the same physical meaning, for example both are amperages or both are voltages. In particular, the actual emergency switch-off threshold is above an instantaneous request of the energy storage device, selected from the current power request, the current voltage request and the current amperage request, and below a limit charging parameter of the same type of the energy storage device, selected from the maximum charging power of the energy storage device, the maximum charging voltage of the energy storage device and the maximum charging amperage of the energy storage device.

Alternatively or additionally, the actual emergency switch-off threshold is set in dependence on a power supply device limit charging parameter of the limit charging parameters and an energy storage device limit charging parameter of the limit charging parameters, wherein in particular the power supply device limit charging parameter and the energy storage device limit charging parameter are compared with each other and the actual emergency switch-off threshold is set in dependence on the lower-value, in particular lower-amount limit charging parameter.

According to a further development of the invention, it is provided that the data of the data transmission between the power supply device and the energy storage device is acquired by means of an acquisition device.

According to a further development of the invention, it is provided that the data is acquired on a line, a charging cable connecting the power supply device to the energy storage device, power electronics, an electrical interface and/or on a control device of the power supply device.

In one embodiment, the data of a data transmission that uses an electrical line in the low-voltage network (Powerline Communication (PLC) and/or a serial bus system (Controller Area Network (CAN) is acquired and/or received. In particular, the acquisition device is configured to receive data of a data transmission that uses an electrical line in the low-voltage network (Powerline Communication (PLC) and/or data of a data transmission that uses a serial bus system (Controller Area Network (CAN). In particular, the electrical line runs from the power supply device to the energy storage device, in particular within a charging cable. In particular, the electrical line is a line different from the power circuit within the charging cable.

Advantageously, the data can be acquired directly or indirectly: The data can be acquired directly by configuring the acquisition device to communicate with the power supply device via a communication interface, preferably a serial bus system or a network interface. Preferably, the acquisition device communicates directly with the control device and/or the power electronics. The data can be acquired indirectly, in that the acquisition device is configured to acquire the data transmission on a data transmission path, in particular without communicating directly with the control device for this purpose. In particular, the data transmission path can be opened, in particular separated, wherein the acquisition device is placed in between and the data transmission path is closed again. Alternatively, it is possible for the acquisition device to detect the data transmission without a galvanic connection to the data transmission path itself—in other words, to listen to the data transmission, in particular electrically contactless, in particular galvanically decoupled, in particular inductively. This is preferably done on the line or charging cable.

In one embodiment, the charging parameter is also acquired directly or indirectly—for example via a voltage that drops across an inductance due to an amperage gradient.

The object is also solved by creating a switch-off control device for a power supply device for unidirectional or bidirectional charging of an energy storage device. The switch-off control device is configured to carry out a method according to the invention or a method according to one or multiple of the previously described embodiments. In connection with the switch-off control device, the advantages already explained in connection with the method apply in particular.

According to a further development of the invention, it is provided that the switch-off control device is configured to be operatively connected to an acquisition device. Furthermore, the switch-off control device is configured to receive data of a data transmission between the power supply device and the energy storage device acquired—directly and/or indirectly—by the acquisition device.

According to a further development of the invention, it is provided that the switch-off control device is configured to be operatively connected to a power circuit of the power supply device and to interrupt the power circuit.

In one embodiment, the switch-off control device is controllably operatively connected to the switch-off arrangement. In particular, the switch-off arrangement is configured to receive an interruption signal from the switch-off control device and then interrupt the power circuit.

In one embodiment, the switch-off arrangement has a first controllable power semiconductor component and a second controllable power semiconductor component. The first power semiconductor component and the second power semiconductor component are arranged antiserially. The first power semiconductor component and the second power semiconductor component are configured to conduct the charging current of the power supply device in a switched-on state. The switch-off control device is operatively connected to the first power semiconductor component and the second power semiconductor component and is configured for their respective control. Furthermore, the switch-off control device is configured to acquire the value of the at least one charging parameter which is characteristic of the charging current and, in dependence on the acquired value, to switch off the first power semiconductor component and/or the second power semiconductor component and thereby interrupt the charging current, in particular the power circuit.

Optionally, the switch-off arrangement has a diode, wherein the diode, the first power semiconductor component and the second power semiconductor component are arranged as a T-circuit.

In the context of the present technical teaching, in particular three electrical components are electrically connected to each other at a single connection point in a T-circuit. A first terminal of the first component, in particular the first power semiconductor component, and a first terminal of the second component, in particular the second power semiconductor component, are electrically connected to each other via the connection point. In addition, the first terminal of the first component and a first terminal of the third component, in particular the diode, are electrically connected to each other via the connection point. In addition, the first terminal of the second component and the first terminal of the third component, in particular the diode, are electrically connected to each other via the connection point. Furthermore, a second terminal of the first component and a second terminal of the third component are connected or connectable to a voltage or current source, in particular the power supply device or the energy storage device. In addition, a second terminal of the second component and the second terminal of the third component are connected or connectable to a load, in particular the energy storage device, wherein the voltage or current source and the load are formed differently.

In particular, the diode takes over the charging current after the interruption, which is then slowly dissipated via the diode. Advantageously, it is possible to dissipate energy from a line inductance of the charging current by means of the diode. The charging current has a high amperage and a low voltage of less than 2 V when conducted via the diode. Furthermore, a switch-off time is also reduced.

In one embodiment, the switch-off arrangement is configured in such a way that a positive charging current is always conducted by the second power semiconductor component. In addition, the switch-off arrangement is configured such that a positive charging current from the first power semiconductor component is interrupted in dependence on the acquired value of the at least one characteristic charging parameter. Furthermore, the switch-off arrangement is configured in such a way that a negative charging current is always conducted by the first power semiconductor component. In addition, the switch-off arrangement is configured such that a negative charging current from the second power semiconductor component is interrupted in dependence on the acquired value of the at least one characteristic charging parameter. In the present case, this is also referred to as an antiparallel arrangement, in particular as “antiparallel”.

In the context of the present technical teaching, a power semiconductor component has at least one positive pole and at least one negative pole. Preferably, a power semiconductor component also has a control terminal, wherein the switch-off control device is electrically connected to the control terminal.

It is particularly preferred that the first power semiconductor component and/or the second power semiconductor component is formed to be unidirectionally blocking.

In one embodiment, it is provided that the switch-off control device is configured to compare the acquired value with the actual emergency switch-off threshold and, in dependence on the comparison, to switch off the first power semiconductor component and/or the second power semiconductor component and thereby interrupt the charging current. Advantageously, it is thus possible to decide in a simple and quick manner whether to switch off the first power semiconductor component and/or the second power semiconductor component.

In one embodiment, the switch-off control device is configured to determine a difference between the acquired value and the actual emergency switch-off threshold, and, in dependence on the difference, to switch off the first power semiconductor component and/or the second power semiconductor component, and thereby interrupt the charging current.

In one embodiment, it is provided that the first power semiconductor component has a first semiconductor switch and a first component diode, wherein the first semiconductor switch and the first component diode are arranged antiparallel. In addition, the second power semiconductor component has a second semiconductor switch and a second component diode, wherein the second semiconductor switch and the second component diode are arranged antiparallel. This ensures that an electric current flowing from the positive pole of the power semiconductor component to the negative pole of the power semiconductor component is conducted through the semiconductor switch, since the component diode is arranged in the reverse direction. Furthermore, an electric current flowing from the negative pole of the power semiconductor component to the positive pole of the power semiconductor component is conducted through the component diode, since the component diode is arranged in the forward direction. Furthermore, due to the antiserial arrangement of the first power semiconductor component and the second power semiconductor component, the first semiconductor switch and the second semiconductor switch are also arranged antiserially in the switch-off unit. Advantageously, the first semiconductor switch and the second semiconductor switch thus form a bidirectional semiconductor switch. Furthermore, the semiconductor switches can be used to quickly interrupt the charging current by means of a corresponding gate signal. In addition, due to the antiserial arrangement of the first power semiconductor component and the second power semiconductor component, the first component diode and the second component diode are also arranged antiserially in the switch-off arrangement.

In one embodiment, the first semiconductor switch and/or the second semiconductor switch is formed as a field-effect transistor, in particular as a metal-oxide-semiconductor field-effect transistor (MOSFET). In particular, the metal-oxide-semiconductor field-effect transistor has a silicon carbide material. If an n-channel field-effect transistor is used, a drain terminal of the field-effect transistor is assigned to the positive pole of the power semiconductor component and a source terminal of the field-effect transistor is assigned to the negative pole of the power semiconductor component. Alternatively, if a p-channel field-effect transistor is used, the source terminal of the field-effect transistor is assigned to the positive pole of the power semiconductor component and the drain terminal of the field-effect transistor is assigned to the negative pole of the power semiconductor component. Particularly preferably, the switch-off control device is configured to acquire the semiconductor forward voltage, in particular a gate-source voltage of the field-effect transistor, and to determine therefrom an amperage and/or a voltage as the at least one charging parameter.

In a further embodiment, the first semiconductor switch and/or the second semiconductor switch is formed as a bipolar transistor with an insulated gate electrode. If an n-channel bipolar transistor is used, a collector terminal of the bipolar transistor is assigned to the positive pole of the power semiconductor component and an emitter terminal of the bipolar transistor is assigned to the negative pole of the power semiconductor component. Alternatively, if a p-channel bipolar transistor is used, the emitter terminal of the bipolar transistor is assigned to the positive pole of the power semiconductor component and the collector terminal of the bipolar transistor is assigned to the negative pole of the power semiconductor component. Particularly preferably, the switch-off control device is configured to acquire the semiconductor forward voltage, in particular a base-emitter voltage of the bipolar transistor, and to determine therefrom an amperage and/or a voltage as the at least one charging parameter.

In one embodiment, the first semiconductor switch and/or the second semiconductor switch is an insulated-gate bipolar junction transistor (IGBT). In particular, it has a silicon material. In particular, this makes it possible to interrupt the charging current so quickly that a short-circuit current occurring in the event of a malfunction does not exceed a value of I=1 kA.

In one embodiment, a cathode of the component diode of the power semiconductor component is assigned to the positive pole of the power semiconductor component and an anode of the component diode of the power semiconductor component is assigned to the negative pole of the power semiconductor component.

In a particularly preferred embodiment, the first of the power semiconductor component and the second of the power semiconductor component are formed identically.

In one embodiment, it is provided that the switch-off control device is configured to switch off the first power semiconductor component and/or the second power semiconductor component by means of the control voltage.

In particular, the control voltage for switching off the first power semiconductor component and/or the second power semiconductor component is preferably at most 0 V. In particular, the first power semiconductor component is switched off and thus the charging current is interrupted if a control voltage of at most 0 V is present at the first power semiconductor component, in particular at a gate terminal of the first power semiconductor component. Furthermore, the second power semiconductor component is switched off and thus the charging current is interrupted if a control voltage of at most 0 V is present at the second power semiconductor component, in particular at a gate terminal of the second power semiconductor component. In particular, the first power semiconductor component and the second power semiconductor component are switched on and thus the charging current is not interrupted if a control voltage of 15 V to 20 V is applied to the first power semiconductor component and the second power semiconductor component, in particular to the respective gate terminals.

In the context of the present technical teaching, an interruption signal is understood in particular to mean an electrical signal. The electrical signal can be a control voltage at a gate terminal of a power semiconductor component.

According to a further development of the invention, it is provided that the switch-off control device is formed by a control device of the power supply device or is formed as the control device of the power supply device. Alternatively, in another embodiment—in particular the retrofit solution described below—it is possible that the switch-off control device is provided separately from the control device of the power supply device, but is preferably operatively connected to it.

In particular, the control device is controllably operatively connected to the switch-off arrangement to transmit the interruption signal to the switch-off arrangement.

The object is also solved by creating a switch-off unit, in particular for retrofitting on a power supply device for unidirectional or bidirectional charging of an energy storage device. The switch-off unit has the switch-off arrangement, which is configured to interrupt a power circuit. Furthermore, the switch-off unit has a switch-off control device according to the invention or a switch-off control device according to one or multiple of the previously described embodiments, which is operatively connected to the switch-off arrangement for the control thereof. In connection with the switch-off unit, the advantages already explained in connection with the method and the switch-off control device apply in particular.

The switch-off unit can advantageously be retrofitted to an existing power supply device. The switch-off arrangement and the switch-off control device can be arranged as a compact module in a single housing. The housing can simply be inserted into the power supply device, for example into a free shaft, and screwed to it. The switch-off arrangement is then operatively connected to the power circuit.

In one embodiment, it is provided that the switch-off unit has the acquisition device for acquiring at least one limit charging parameter which is characteristic of a charging process. The acquisition device is operatively connected to the switch-off control device and configured to transmit the at least one limit charging parameter to the switch-off control device. The acquisition device can advantageously also be arranged in the housing of the switch-off unit. In particular, the acquisition device is then connected to the control device of the power supply device in such a way as to directly acquire data from the data transmission. Alternatively, the acquisition device is arranged outside the housing and connected to the data transmission path to indirectly acquire data from the data transmission. In particular, the acquisition device can simply be placed or clamped around a charging cable or otherwise attached to the charging cable.

In particular, the switch-off arrangement is configured to receive the interruption signal from the switch-off control device and then interrupt the power circuit.

The object is also solved by creating a power supply device for unidirectional or bidirectional charging of an energy storage device. The power supply device has power electronics configured to selectively close or open a power circuit for unidirectional or bidirectional charging of the energy storage device. The power supply device additionally has a switch-off unit according to the invention or a switch-off unit according to one or multiple of the embodiments described above or a switch-off control device according to the invention or a switch-off control device according to one or multiple of the embodiments described above. Furthermore, the power supply device has an electrical interface configured to be connected to an energy storage device for preferably bidirectional charging. In connection with the power supply device, the advantages already explained in connection with the method, the switch-off control device and the switch-off unit apply in particular.

According to a further development of the invention, it is provided that the switch-off control device is integrated into a control device of the power supply device. Alternatively, it is provided that the switch-off control device is formed as a control device of the power supply device. Alternatively, the switch-off control device is arranged separately from the control device of the power supply device, but preferably operatively connected thereto.

In one embodiment—if the switch-off control device is integrated into a control device of the power supply device or if the switch-off control device is formed as a control device of the power supply device—the control device is controllably operatively connected to the switch-off arrangement. Optionally, the control device is operatively connected to the acquisition device to receive data from the data transmission. In particular, the switch-off arrangement is configured to receive the interruption signal from the control device and then interrupt the power circuit.

In another embodiment—if the switch-off control device is arranged separately from the control device, i.e. the power supply device has a switch-off unit, i.e. in particular is retrofitted therewith—the switch-off control device is controllably operatively connected to the switch-off arrangement.

Optionally, the switch-off control device is operatively connected to the acquisition device to receive data from the data transmission. In particular, the switch-off arrangement is configured to receive the interruption signal from the control device and then interrupt the power circuit.

According to a further development of the invention, it is provided that the acquisition device is arranged on a line, a charging cable connecting the power supply device to the energy storage device, the power electronics, the electrical interface and/or on the control device, in particular for acquisition.

In one embodiment, the switch-off arrangement, in particular the first power semiconductor component and the second power semiconductor component, is electrically installed in series with an energy storage device connectable to the power supply device in a power circuit of the power supply device.

The invention is explained in more detail below with reference to the drawing. The Figures show:

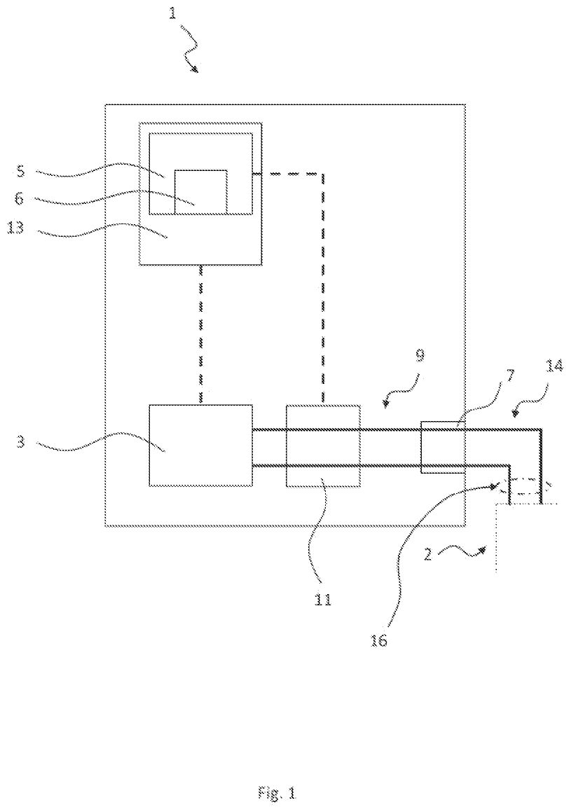

FIG. 1 shows a schematic representation of an embodiment example of a power supply device,

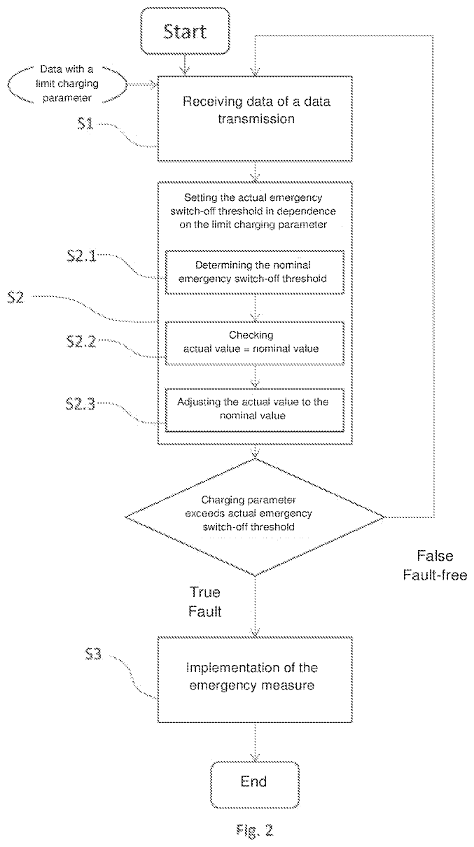

FIG. 2 shows a schematic representation of a process flow diagram of an embodiment example of a method for operating the electrical power supply device 1 according to FIG. 1,

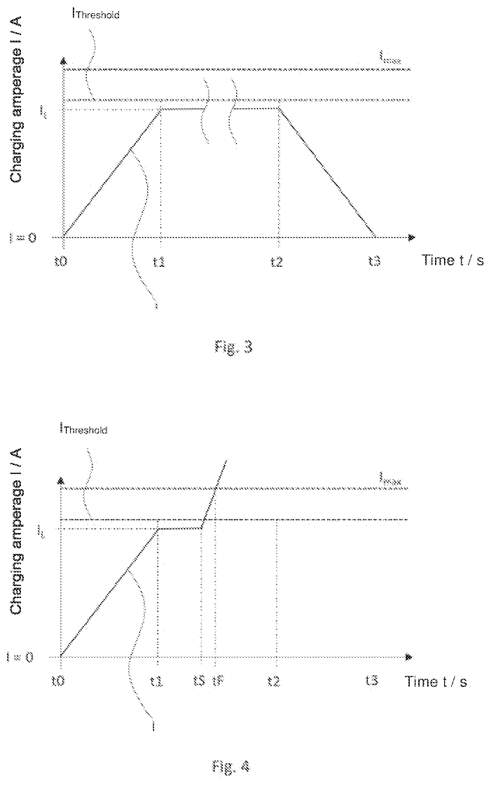

FIG. 3 shows a schematic representation of a charging amperage curve of a fault-free charging process that is monitored using a first embodiment example of the method shown in FIG. 2,

FIG. 4 shows a schematic representation of a charging amperage curve of a faulty charging process that is monitored using a first embodiment example of the method shown in FIG. 2,

FIG. 5 shows a schematic representation of a charging amperage curve of a fault-free charging process that is monitored using a second embodiment example of the method shown in FIG. 2, and

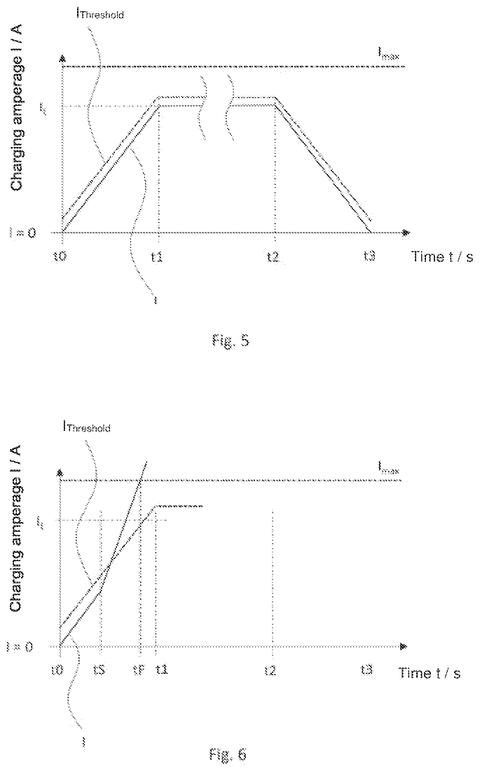

FIG. 6 shows a schematic representation of a charging amperage curve of a faulty charging process that is monitored using the second embodiment example of the method shown in FIG. 2.

FIG. 1 shows a schematic representation of an embodiment example of a power supply device 1 for charging, in particular, an energy storage device 2, in particular a battery storage of an electric vehicle.

The power supply device 1 comprises power electronics 3, a switch-off control device 5 and an electrical interface 7. The power electronics 3 is configured—controlled by a control device 13—to selectively close or open a power circuit 9 for charging an energy storage device 2. The electrical interface 7 is configured to be connected to the energy storage device 2 for charging the energy storage device 2. In the present case, the electrical interface 7 is connected to the energy storage device 2 by means of a charging cable 14.

The power supply device 1 also has a switch-off arrangement 11. The switch-off control device 5 is configured to be operatively connected to the power circuit 9 of the power supply device 1—mediated via the switch-off arrangement 11—and to interrupt the power circuit 9. For this purpose, the switch-off control device 5 is controllably operatively connected to the switch-off arrangement 11. The switch-off arrangement 11 is again configured to receive an interruption signal from the switch-off control device 5 and then interrupt the power circuit 9.

The switch-off control device 5 is integrated into a control device 13 of the power supply device 1 or is formed as a control device 13 of the power supply device 1. The switch-off control device 5 is configured to be operatively connected to an acquisition device 6. Furthermore, the switch-off control device 5 is configured to receive data acquired—directly and/or indirectly—by the acquisition device 6 from a data transmission between the power supply device 1 and the energy storage device 2.

In an embodiment example not shown, the power supply device 1 has a switch-off unit that is in particular retrofitted. The switch-off unit has the switch-off arrangement 11, which is configured to interrupt the power circuit 9. Furthermore, the switch-off unit has the switch-off control device 5, which is different from the control device 13 and is operatively connected to the switch-off arrangement 11 for the control thereof. Optionally, the switch-off unit has the acquisition device 6. The acquisition device 6 can detect the data transmission without a galvanic connection to a data transmission path itself—in other words, listen to the data transmission, in particular electrically contactless, in particular galvanically decoupled, in particular inductively. This is preferably done on a line or the charging cable 14, for example—as indicated here by a dashed line—with a preferably inductive data sniffer 16 as the acquisition device 6.

The power supply device 1 and the switch-off control device 5 are in particular configured to carry out a method described in more detail below for operating the electrical power supply device 1.

FIG. 2 shows a schematic representation of a process flow diagram of an embodiment example of a method for operating the electrical power supply device 1 according to FIG. 1 for charging the energy storage device 2.

Identical and functionally identical elements are provided with the same reference numbers in all Figures, so that reference is made to the previous description in each case.

In the method, in a first step S1, data of a data transmission between the power supply device 1 and the energy storage device 2 is received during a charging process. The data contains at least one limit charging parameter which is characteristic for the charging process. In a second step S2, in dependence on the at least one limit charging parameter, an actual emergency switch-off threshold of the power supply device 1 is set for a charging parameter. If the charging parameter exceeds the actual emergency switch-off threshold, in a third step S3, an emergency measure is carried out, in particular to protect the power supply device 1 and/or the energy storage device 2 from damage. As an emergency measure, a power circuit 9 of the power electronics 3, in particular of the power supply device 1 and/or the energy storage device 2, is interrupted, in particular in such a way that the charging process is interrupted.

Here, a charging current from the power supply device 1 to the energy storage device 2 and vice versa—which is known as bidirectional charging—can preferably be monitored.

The actual emergency switch-off threshold in the second step S2 is set by determining a nominal emergency switch-off threshold of the power supply device 1 for the charging parameter in a first second step S2.1 of the second step S2, in dependence on the at least one limit charging parameter.

In a second second step S2.2 of the second step S2, it is checked whether a current actual value of the actual emergency switch-off threshold of the power supply device 1 is equal to a nominal value of the nominal emergency switch-off threshold, in particular whether it has the same value. If the current actual value is not equal to the nominal value, in particular does not have the same value, the actual emergency switch-off threshold is adjusted in a third second step S2.3 of the second step S2 so that a new actual value of the actual emergency switch-off threshold is equal to the nominal value, in particular has the same value.

Preferably, the method or at least one step of the method is repeated, in particular cyclically, in particular at a frequency of 10 kHz to 50 kHz. In particular, the actual emergency switch-off threshold is set once at the beginning of the charging process (see FIGS. 3 and 4—first embodiment example—). Alternatively or additionally, the actual emergency switch-off threshold is set repeatedly, in particular cyclically, during the charging process (see FIGS. 5 and 6—second embodiment example—).

FIG. 3 shows a schematic representation of a charging amperage curve of a fault-free charging process that is monitored using the first embodiment example of the method shown in FIG. 2.

In this second embodiment example of the method, the actual emergency switch-off threshold is set to a constant value only once at the beginning of the charging process. For this purpose, data of the data transmission between the power supply device 1 and the energy storage device 2 is received at least at the beginning of the charging process, wherein the data contains at least one limit charging parameter which is characteristic of the charging process. In the present case, a maximum charging current Iₘₐₓ of the energy storage device is selected as the limit charging parameter.

The diagram shows a charging amperage curve of a fault-free charging process in which the power supply device 1 is charged by the energy storage device 2. Alternatively, the energy storage device 2—mediated via the power supply device 1—can also support or stabilize a power grid, for example.

In the diagram, a charging amperage I in amperes (A) is plotted against the time t in seconds(s). The charging process begins at a start time t0 and the charging amperage I—as a charging parameter—is increased starting at 0 A until a predetermined charging amperage I_{L} is reached at a first point in time t1. Between the points in time t0 and t1, the charging amperage I is increased linearly over time, for example. It is also conceivable that the charging amperage I is increased non-linearly, for example progressively. Between the first point in time t1 and a second point in time t2, the power supply device 1 is charged with the constant charging amperage I_{L}. From the second point in time t2, the charging amperage I is reduced until the charging process is completed at a third point in time t3. Between the points in time t2 and t3, the charging amperage I is reduced linearly over time, for example. It is also conceivable here that the charging amperage I is reduced non-linearly, for example regressively. The charging process between the points in time t1 and t2 usually takes significantly longer-multiple minutes to hours—than increasing and decreasing the charging amperage I, which usually takes a few seconds to a minute.

In this first embodiment example, the power supply device 1 receives the data of the data transmission containing the information that the maximum charging amperage Iₘₐₓ of the energy storage device 2—as a limit charging parameter—is a certain maximum value. If this is exceeded, the fuse of the energy storage device 2 is tripped. For example, an electric vehicle would then no longer be roadworthy. Depending on the maximum charging amperage Iₘₐₓ, the actual emergency switch-off threshold—as charging amperage threshold I_{threshold}—is set for the charging parameter in such a way that the magnitude of the actual emergency switch-off threshold is smaller than the maximum charging amperage Iₘₐₓ.

At all points in time during this charging process, the charging parameter—the charging amperage I—is smaller than the actual emergency switch-off threshold—the charging amperage threshold I_{threshold}. As long as the charging parameter is smaller than the actual emergency switch-off threshold, no emergency measure is carried out.

FIG. 4 shows a schematic representation of a charging amperage curve of a faulty charging process that is monitored using a first embodiment example of the method shown in FIG. 2.

The diagram in FIG. 4 corresponds to the diagram in FIG. 3, with the difference that the charging process does not proceed fault-free here. At the fault time tS, the power supply device 1 is short-circuited due to a fault. The charging parameter rises steeply.

When using a power supply device 1 of the prior art, the fault would cause the charging amperage I to increase for so long and to such an extent that at a fault time tF the maximum charging amperage Iₘₐₓ of the energy storage device of the fuse of the energy storage device 2 is exceeded. If the energy storage device 2 is a battery of an electric vehicle, the electric vehicle would no longer be functional after the fault time tF.

This can be prevented by implementing the present method. Since the actual emergency switch-off threshold is set below the maximum charging amperage Iₘₐₓ of the energy storage device, the emergency measure can be carried out before the maximum charging amperage Iₘₐₓ of the energy storage device is reached and the power circuit 9 of the power electronics 3, in particular the power supply device 1 or the energy storage device 2, can be interrupted, in particular in such a way that the charging process is interrupted. The power circuit 9 of the power electronics 3 is interrupted at such an early stage that the fuse of the energy storage device 2 is not exposed to the fault of the charging process, in particular the fuse is not tripped. If the energy storage device 2 is a battery of an electric vehicle, the electric vehicle would continue to be functional.

FIG. 5 shows a schematic representation of a charging amperage curve of a fault-free charging process that is monitored using the second embodiment example of the method shown in FIG. 2.

In this second embodiment example of the method, the actual emergency switch-off threshold—as the charging current intensity threshold I_{threshold}—is set repeatedly, in particular cyclically. In contrast to the limit charging parameter in FIGS. 3 and 4, the limit charging parameter selected here is an instantaneous amperage request of the energy storage device 2. The diagram in FIG. 5 also corresponds to the diagram in FIG. 3.

The fact that the actual emergency switch-off threshold is set repeatedly and in dependence on the current amperage request means that the actual emergency switch-off threshold follows a curve of the charging parameter. This can be seen in particular between the points in time t0 and t1 as well as t2 and t3.

At all points in time during this charging process, the charging parameter—the charging amperage I—is smaller than the actual emergency switch-off threshold—the charging amperage threshold I_{threshold}. As long as the charging parameter is smaller than the actual emergency switch-off threshold, no emergency measure is carried out.

FIG. 6 shows a schematic representation of a charging amperage curve of a faulty charging process that is monitored using the second embodiment example of the method shown in FIG. 2.

The diagram in FIG. 6 corresponds to the diagram in FIG. 5, with the difference that the charging process does not proceed fault-free here. At the fault time tS—which here lies between the points in time to and t1, in contrast to FIG. 4—the power supply device 1 is short-circuited due to a fault. The charging parameter rises steeply.

When using a power supply device 1 of the prior art, the fault would also cause the charging amperage I to increase for so long and to such an extent that at a fault time tF the maximum charging amperage Iₘₐₓ of the fuse of the energy storage device 2—as limit charging parameter—is exceeded. If the energy storage device 2 is a battery of an electric vehicle, the electric vehicle would no longer be functional after the fault time tF.

This can be prevented by implementing the present method. The actual emergency switch-off threshold is set repeatedly in dependence on the current amperage request, wherein the current amperage request can change over time, for example at the start and end of the charging process. The actual emergency switch-off threshold is thus flexible or dynamic, i.e. variable in time in particular during the charging process. Since this is set only just above the current amperage request, the emergency measure can be carried out long before the maximum charging amperage Iₘₐₓ of the energy storage device is reached and the power circuit 9 of the power electronics 3, in particular the power supply device 1 or the energy storage device 2, can be interrupted, in particular in such a way that the charging process is interrupted. The power circuit 9 of the power electronics 3 is interrupted at such an early stage that the fuse of the energy storage device 2 is not exposed to the fault of the charging process, in particular the fuse is not tripped. If the energy storage device 2 is a battery of an electric vehicle, the electric vehicle would continue to be functional.

1. A method for operating an electrical power supply device (1) for unidirectional or bidirectional charging of an energy storage device (2), wherein
data of the data transmission between the power supply device (1) and the energy storage device (2) is received at least during a charging process, wherein the data contains at least one limit charging parameter which is characteristic of the charging process, wherein
in dependence on the at least one limit charging parameter, an actual emergency switch-off threshold of the power supply device (1) is set for a charging parameter, wherein
if the charging parameter exceeds the actual emergency switch-off threshold, an emergency measure is carried out to protect the power supply device (1) and/or the energy storage device (2) from damage.

2. The method according to claim 1, wherein
the actual emergency switch-off threshold is set by determining a nominal emergency switch-off threshold of the power supply device (1) for the charging parameter in dependence on the at least one limit charging parameter, wherein
it is checked, whether a current actual value of the actual emergency switch-off threshold of the power supply device (1) is equal to a nominal value of the nominal emergency switch-off threshold, wherein
if the current actual value is not equal to the nominal value, the actual emergency switch-off threshold is adjusted so that a new actual value of the actual emergency switch-off threshold is equal to the nominal value.

3. The method according to one of the preceding claims, wherein, as an emergency measure, a power circuit (9) of power electronics (3), in particular of the power supply device (1) and/or of the energy storage device (2), is interrupted.

4. The method according to one of the preceding claims, wherein the limit charging parameter is selected from a group consisting of: A maximum charging power of the power supply device (1), a maximum charging power of the energy storage device (2), a maximum charging voltage of the power supply device (1), a maximum charging voltage of the energy storage device (2), a maximum charging amperage of the power supply device (1), a maximum charging amperage of the energy storage device (2), an instantaneous power request of the energy storage device (2), an instantaneous power request of the power supply device (1), an instantaneous voltage request of the energy storage device (2), an instantaneous voltage request of the power supply device (1), an instantaneous amperage request of the energy storage device (2), an instantaneous amperage request of the power supply device (1), an instantaneous charging power gradient, an instantaneous charging voltage gradient and an instantaneous charging amperage gradient.

5. The method according to one of the preceding claims, wherein
the actual emergency switch-off threshold is additionally set in dependence on a first tolerance value, wherein
the first tolerance value is characteristic of a tolerance of the charging process, in particular of the charging parameter.

6. The method according to one of the preceding claims, wherein
the data of the data transmission between the power supply device (1) and the energy storage device (2) is acquired by means of an acquisition device (6).

7. The method according to one of the preceding claims, wherein
the data is acquired on a line, a charging cable (14) connecting the power supply device (1) to the energy storage device (2), power electronics (3), an electrical interface (7) and/or on a control device (13) of the power supply device (1).

8. A switch-off control device (5) for a power supply device (1) for unidirectional or bidirectional charging of an energy storage device (2), wherein the switch-off control device (5) is configured to perform a method according to one of the preceding claims.

9. The switch-off control device (5) according to claim 8, wherein
the switch-off control device (5) is configured to be operatively connected to an acquisition device (6), and to
receive data acquired by the acquisition device (6) from a data transmission between the power supply device (1) and the energy storage device (2).

10. The switch-off control device (5) according to claim 8 or 9, wherein
the switch-off control device (5) is configured to be operatively connected to a power circuit (9) of the power supply device (1) and to interrupt the power circuit (9).

11. The switch-off control device (5) according to one of claims 8 to 10, wherein
the switch-off control device (5) is formed by a control device (13) of the power supply device (1).

12. A switch-off unit, in particular for retrofitting on a power supply device (1) for unidirectional or bidirectional charging of an energy storage device (2), with
a switch-off arrangement (11) which is configured to interrupt a power circuit (9), and
a switch-off control device (5) which is operatively connected to the switch-off arrangement (11) for the control thereof according to one of claims 8 to 11, wherein optionally
the switch-off unit has an acquisition device (6) for acquiring at least one limit charging parameter which is characteristic of a charging process, which is operatively connected to the switch-off control device (5) and is configured to transmit the at least one limit charging parameter to the switch-off control device (5).

13. A power supply device (1) for unidirectional or bidirectional charging of an energy storage device (2), comprising:
power electronics (3) which is configured to selectively close or open a power circuit (9) for charging an energy storage device (2);
a switch-off unit according to claim 12 or a switch-off control device (5) according to one of claims 8 to 11, and
an electrical interface (7), configured to be connected to the energy storage device (2) for charging the energy storage device (2).

14. The power supply device (1) according to claim 13, wherein
the switch-off control device (5) is integrated into a control device (13) of the power supply device (1) or is formed as a control device (13) of the power supply device (1).

15. The power supply device (1) according to claim 13 or 14, wherein
the acquisition device (6) is arranged on a line, a charging cable (14) connecting the power supply device (1) to the energy storage device (2), the power electronics (3), the electrical interface (7) and/or on the control device (13).
